(19) United States
(12) Patent Application Publication
(10) Pub. No.: US 2009/0309649 A1
(43) Pub. Date: Dec. 17, 2009

(54) ACTIVE BAND-PASS FILTER AND MAGNETIC STORAGE DEVICE

(75) Inventor: Isao Tsuyama, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/410,264

(22) Filed: Mar. 24, 2009

(30) Foreign Application Priority Data
Jun. 12, 2008 (JP) 2008-154484

(51) Int. Cl. H04B 1/10

(52) U.S. Cl. 327/557

(57) ABSTRACT

An active band-pass filter has a negative feedback circuit including a series-connection of a band-pass block, a second-order band-elimination block having a denominator polynomial equal to the band-pass block and an amplifier block which amplifies the output of the band-elimination block. The band width can be controlled independently of the frequency, adjustment is made easy, and moreover the circuit configuration can be simplified.

### CROSS-REFERENCE TO RELATED APPLICATION

This application is based upon and claims the benefit of priority of the prior Japanese Patent Application No. 2008-154484, filed on Jun. 12, 2008, the entire contents of which are incorporated herein by reference.

### FIELD

The embodiments discussed herein are related to an active band-pass filter which extracts a specific frequency component from a signal and to a magnetic storage device.

### BACKGROUND

A band-pass filter circuit is used in applications to extract a specific frequency component from a signal. Such a circuit is used, for example, when detecting a signal which is needed from among signals buried in noise (as in cosmic radio wave measurements, electrocardiogram measurements, and similar), and when demodulating modulated signals and similar in communication systems, control systems, and magnetic storage devices.

When a band-pass filter used in such various applications is applied to a certain system, it is desirable that the parameters can be adjusted freely and simply according to the state of the system. The principal parameters of a band-pass filter are the center frequency and the pass band width.

Device to electronically adjust the center frequency is generally provided in the field of active filters. In such band-pass filters, there is a need to independently adjust the center frequency and the pass band width.

As such a method in the prior art, in a band-pass filter in which two Gm amplifiers are formed in a loop, a first method for adjusting only the band width with the center frequency set through control of the product and ratio (the Gm values of the Gm amplifier) of the control currents of the first Gm amplifier and the second Gm amplifier, has been proposed (see for example Patent Document 1).

Further, as a second method of the prior art, a method has been proposed in which, in a band-pass filter in which two Gm amplifiers are formed in a loop, a gain control amplifier (GCA) is inserted, and by controlling the gain, the Q factor and the center frequency f0 are adjusted independently (see for example Patent Document 2).

The second method of the prior art is explained in FIG. 12. The first Gm amplifier 11 and second Gm amplifier 13 are connected in a loop to form a band-pass filter, and moreover two amplifier circuits, which are a first gain control amplifier 15 connected on one side of the first capacitor 16, and a second gain control amplifier 23 connected to the inverted input terminal of the second Gm amplifier 13 (output of the inverting circuit 18), are provided.

And, the conversion amounts r11, r13 of each of the amplifiers 11, 13 of the first control unit 24 are made variable, and the gains K of each of the gain control amplifiers 15, 23 are controlled by the control signals of the second control portion 25. Here, if the conversion amounts of the first capacitors 16, 20 are C16 and C20, then in Patent Document 2, the center frequency f0 is expressed by equation (1) below.

[E1]

f0=1/2π·√(C16·C20·r11·r13) (1)

Here the Q factor is given by equation (2) below.

[E2]

Q=(1/K)·√(C16·r11C20·r13) (2)

That is, by controlling r11 and r13 of the Gm amplifiers 11 and 13, the f0 and Q factors are controlled as in the equations (1) and (2), and by controlling each of the gains K of the gain control amplifiers 15 and 23, the value of Q can be changed as in equation (2). Hence by controlling r11 and r13 of the Gm amplifiers 11 and 13 and each of the gains K of the gain control amplifiers 15 and 23, the values of f0 and Q can be controlled independently.

[Patent Document 1] Japanese Patent Application Laid-open No. 2005-184652 (FIG. 1, equation (17), equation (23), equation (24)

[Patent Document 2] Japanese Patent Application Laid-open No. H8-237076 (FIG. 1, equation (4) through equation (6)

In the first technology of the prior art, the gm values of the first and second Gm amplifiers are each functions of the two power supply currents I1 and I2, and the condition for holding the center frequency ω constant is that the product of I1 and I2 be maintained at the square of I0 (=constant). The differential current Ix between I1 and I2 becomes the parameter used to change the value of Q, and the value of Q is a bilinear function of Ix, and is nonlinear.

In other words, the Q factor can be changed independently of the frequency ω, but this adjustment is subject to the above-described constraint. In the equation for adjustment of Q, Ix is related to both the numerator and the denominator, so that adjustment is complex. In particular, in order to obtain a high Q factor (when the differential current Ix is made large), the denominator tends to become small relative to the numerator, and so the adjustment sensitivity is high.

Also, in order to adjust the Q factor, stable supply of the Gm amplifier driving current is sacrificed. That is, when a high Q factor is necessary, that is, when the differential current Ix is made large, the operating currents of the two Gm amplifiers become more unbalanced, and so impediments to circuit operation are conceivable.

On the other hand, in the second technology of the prior art, two gain control amplifiers are required in order to make a single parameter K variable, so that there is the problem of increased circuit scale. That is, although in the above-described publication the gain control amplifier is disclosed only in the form of a function block, the gain is essentially given by the ratio of two gm values, and so it is thought that a single gain control amplifier is equivalent to two Gm amplifiers. For example, if the circuit of FIG. 12 is replaced with a configuration employing only Gm amplifiers, then a minimum of six Gm amplifiers would be required.

Further, in the above-described publication, the circuit configuration is limited to one-end (single-end) operation, so that no problems arise when large-amplitude signals are handled, but such circuits are ineffective when processing signals with small amplitudes and in application to balanced transmission lines. For example, when handling differential signals, two circuits equivalent to that of FIG. 12 must be prepared, and the circuit scale includes 12 Gm amplifiers.

Further, as is clear from equation (2), the Q factor is proportional to the reciprocal of K, so that for linear changes in K, the change in the Q factor is nonlinear, and so the difficulty of adjustment is a problem.

And, when for some reason a gain control amplifier malfunctions and signals are interrupted (that is, when K=0), as can be seen from equation (2), the Q factor goes to infinity, the circuit becomes unstable, and in some cases, there are concerns that oscillation may be induced. In particular, when the first gain control amplifier 15 among the two gain control amplifiers is disconnected, the Q factor goes to infinity. When the second gain control amplifier 23 is disconnected, the overall transfer function itself goes to zero, and the functions of the circuit itself disappear.

### SUMMARY

Accordingly, it is an object in one aspect of the invention to provide an active band-pass filter enabling the easy adjustment of the pass band width, independently of the center frequency, as well as of a magnetic storage device.

According to an aspect of the invention, an active band-pass filter, including: a band-pass block; a band-elimination block, which blocks a prescribed band of signals branched from the input to the band-pass block; an amplifier block, which amplifies output of the band-elimination block; and a signal combining block, which adds together the input to the band-pass block and the inverted signal of the output of the amplifier block, and feeds back the result to the band-pass block, wherein a pass band width is adjusted by setting amplification for the signal amplifier block.

Also according to an aspect of the invention, a magnetic storage device, including a read element which reads signals from a recording medium and a frequency filter which passes in a prescribed band centered on a center frequency the signals read by the read element, wherein the frequency filter includes: a band-pass block; a band-elimination block, which blocks a prescribed band of signals branched from input to the band-pass block; an amplifier block, which amplifies output of the band-elimination block; and a signal combining block, which adds together the input to the band-pass block and the inverted signal of the output of the amplifier block, and feeds back the result to the band-pass block, and wherein a pass band width is adjusted by setting amplification for the signal amplifier block.

For a band-pass block, by configuring a negative feedback circuit using a series-connected circuit of a second-order band-elimination block having a denominator polynomial equal to the band-pass block and an amplifier block which amplifies the output of the band-elimination block, through the amplification of the amplifier block, the band width can be controlled independently of the frequency, adjustment is made easy, and moreover the circuit configuration can be simplified.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a first embodiment of an active band-pass filter of this invention;

FIG. 2 is a block diagram of a second embodiment of an active band-pass filter of the invention;

FIG. 3 is a block diagram of the band-pass filter of a third embodiment of the invention;

FIG. 4 is a block diagram of the band-pass filter of a fourth embodiment of the invention;

FIG. 5 is a block diagram of the band-pass filter of a fifth embodiment of the invention;

FIG. 6 is a circuit configuration diagram where integrators of FIG. 5 are constructed with Gm amplifiers;

FIG. 7 is a block diagram of one embodiment of a magnetic storage device using an active band-pass filter of this invention;

FIG. 8 is an explanatory diagram of flying height detection in the magnetic storage device of FIG. 7;

FIG. 9 is an explanatory diagram of detection operation in the normal flying height region for FIG. 8,

FIG. 10 is an explanatory diagram of detection operation in an abnormal flying height region of FIG. 8,

FIG. 11 is a block diagram of an oscillation circuit and detection circuit of FIG. 7.

FIG. 12 is an explanatory diagram of the conventional active band-pass filter.

### DESCRIPTION OF EMBODIMENTS

Below, embodiments of the invention are explained, in the order of the configuration of an active band-pass filter, the configuration of another active band-pass filter, control of the flying height in a magnetic storage device using an active band-pass filter, and other embodiments; however, the invention is not limited to these embodiments.

(Configuration of an Active Band-Pass Filter)

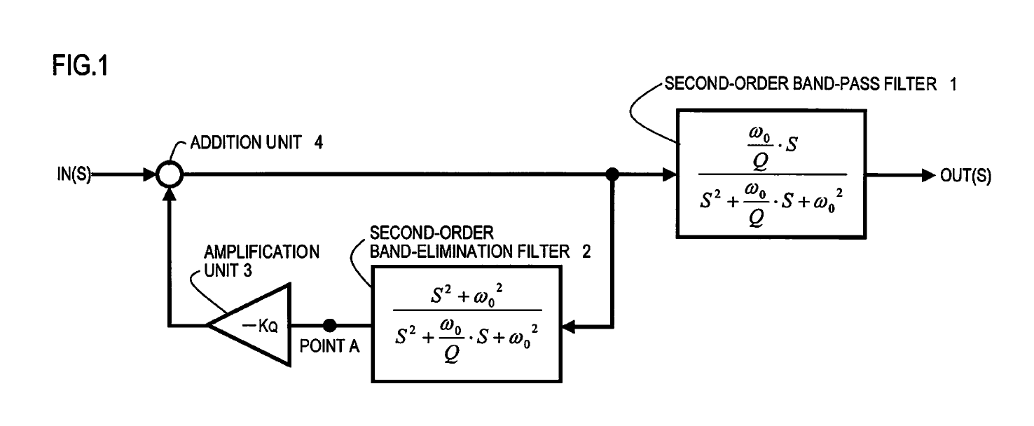

FIG. 1 is a transfer function block diagram of a first embodiment of an active band-pass filter of this invention.

First, a method of this invention of independently setting the pass band width is explained. When the Q factor (selectivity) of the band-pass filter is fixed, if the center frequency changes for some reason, the pass band width also changes proportionally. When the pass band width is adjusted to some arbitrary value independently of the center frequency, it must be possible to electronically vary the Q factor. The configuration of a band-pass filter is considered which enables arbitrary and independent modification of the Q factor only, separately from the resonance angular frequency (center frequency) ω0.

Upon studying the relation between the pass band width, the center frequency, and the Q factor, raising the center frequency without changing the pass band width is equivalent to raising the Q factor in proportion to the center frequency, and conversely, changing the pass band width without changing the center frequency is equivalent to changing the Q factor in proportion to the pass band width (this is called Q multiplication). In a general second-order band-pass filter, the band-pass filter transfer function TBPF(S) when the Q factor multiplication coefficient is α is expressed by equation (3) below.

$$\begin{matrix}[ E 3 ] & \\ {T}_{BPF} ( S ) = \frac{\frac{{ω}_{0}}{α \cdot Q} \cdot S}{{S}^{2} + \frac{{ω}_{0}}{α \cdot Q} \cdot S + {ω}_{0}^{2}} & ( 3 )\end{matrix}$$

In equation (3), s is the Laplace transform, ω0 is the resonance angular frequency (center frequency), and Q is the Q factor.

The equation (3) can be rewritten as the partial product of equation (4).

$$\begin{matrix}[ E 4 ] & \\ \begin{matrix}{T}_{BPF} ( S ) = \frac{\frac{1}{α} \cdot ( {S}^{2} + \frac{{ω}_{0}}{Q} \cdot S + {ω}_{0}^{2} )}{{S}^{2} + \frac{{ω}_{0}}{α \cdot Q} \cdot S + {ω}_{0}^{2}} \cdot \frac{\frac{{ω}_{0}}{Q} \cdot S}{{S}^{2} + \frac{{ω}_{0}}{Q} \cdot S + {ω}_{0}^{2}} \\ ≡ {F}_{Q} ( S ) \cdot {T}_{BPF 0} ( S )\end{matrix} & ( 4 )\end{matrix}$$

In equation (4), the second multiplicand is the band-pass filter basic transfer function TBPF0(S). And, the first multiplicand in equation (4) is a function for a certain type of Q multiplication.

That is, the Q multiplication function FQ(S) is given by the following equation (5).

$$\begin{matrix}[ E 5 ] & \\ \begin{matrix}Q multiplication function \text{:} {F}_{Q} ( S ) = \frac{\frac{1}{α} \cdot ( {S}^{2} + \frac{{ω}_{0}}{Q} \cdot S + {ω}_{0}^{2} )}{{S}^{2} + \frac{{ω}_{0}}{α \cdot Q} \cdot S + {ω}_{0}^{2}} \\ = \frac{{S}^{2} + \frac{{ω}_{0}}{Q} \cdot S + {ω}_{0}^{2}}{α \cdot ( {S}^{2} + {ω}_{0}^{2} ) + \cdot \frac{{ω}_{0}}{Q} \cdot S}\end{matrix} & ( 5 )\end{matrix}$$

Here, the multiplication coefficient α is defined by equation (6) below.

[E6]

α=K₀+1 (6)

Upon substituting equation (6) into equation (5), the Q multiplication function FQ(S) of equation (7) is obtained.

$$\begin{matrix}[ E 7 ] & \\ \begin{matrix}{F}_{Q} ( S ) = \frac{{S}^{2} + \frac{{ω}_{0}}{Q} \cdot S + {ω}_{0}^{2}}{( {K}_{Q} + 1 ) \cdot ( {S}^{2} + {ω}_{0}^{2} ) + \frac{{ω}_{0}}{Q} \cdot S} \\ = \frac{1}{1 + {K}_{Q} \cdot \frac{{S}^{2} + {ω}_{0}^{2}}{{S}^{2} + \frac{{ω}_{0}}{Q} \cdot S + {ω}_{0}^{2}}} \\ ≡ \frac{μ}{1 + μ \cdot β}\end{matrix} & ( 7 )\end{matrix}$$

The form of equation (7) is the form of a negative feedback circuit. That is, the Q multiplication function can be configured as a negative feedback circuit. The elements μ and β of the Q multiplication function FQ(S) of this negative feedback circuit are expressed by equation (8) below.

$$\begin{matrix}[ E 8 ] & \\ \{ \begin{matrix}μ = 1 \\ β = {K}_{Q} \cdot \frac{{S}^{2} + {ω}_{0}^{2}}{{S}^{2} + \frac{{ω}_{0}}{Q} \cdot S + {ω}_{0}^{2}} = {K}_{Q} \cdot {T}_{BEF} ( S )\end{matrix} \} & ( 8 )\end{matrix}$$

In equation (8), the feedback element β has the form of the product the coefficient KQ and the band-elimination filter transfer function TBEF(S). That is, the feedback element has the form of frequency-selective feedback which is a feedback type having an arbitrary frequency characteristic. This is used when emphasizing a target characteristic by making the frequency-selective feedback such that there is negative feedback of the inverse characteristic of the target frequency characteristic.

The Q amplification type band-pass filter of this embodiment further emphasizes the band pass characteristic by negative feedback at the input of a band-elimination characteristic which is the inverse characteristic of the target band-pass characteristic, as indicated by the feedback element β in equation (8). If KQ is regarded as the amplifier gain, then by adjusting this gain, the Q factor can be varied.

FIG. 1 is a transfer function block diagram of a band-pass filter with variable pass band width based on the above concept. As indicated by FIG. 1, the band-pass filter with variable pass band width includes a second-order band-pass block (band-pass filter) 1, a second-order band-elimination filter 2 having a denominator polynomial equal to the band-pass block 1, an amplifier block 3 which amplifies the output of the band-elimination block 2, and an adder block 4 which adds the input of the second-order band-pass block 1 and the output of the amplifier block 3. The minus sign “−” of the transfer function block of the amplifier block 3 indicates signal “inversion”.

According to this configuration, by adjusting the gain KQ of the amplifier block 3, the Q factor can be changed. As is clear from equation (6) as well, the Q factor multiplication coefficient α is proportional to the gain K, so that for a linear change in K, the Q factor also changes linearly. For this reason, adjustment of the pass band width is easy.

Further, a differential configuration can be adopted, so that the circuit scale can be reduced. Further, from equation (6), the form (1+K) is employed, so that even when the negative feedback side (K) is disconnected, Q0 remains as the initial value, and so at a minimum the function of the band-pass filter can be maintained.

(Another Active Band-Pass Filter Configuration)

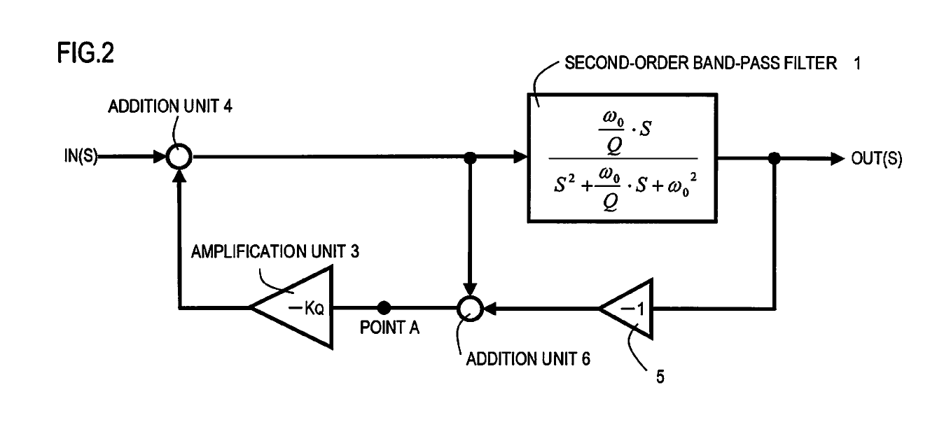

FIG. 2 is the transfer function block diagram of a second embodiment of an active band-pass filter of the invention. In FIG. 2, portions which are the same as those shown in FIG. 1 are assigned the same symbols.

As indicated by FIG. 2, the active band-pass filter includes a second-order band-pass block (band-pass filter) 1, an amplifier block 3, an adder block 4, an inverter block 5, and a second adder block 6. Compared with the first embodiment of FIG. 1, the second embodiment has the appearance of a configuration with the band-elimination filter 2 removed.

The reason for this is that the transfer function of the band-elimination filter is obtained by subtracting the transfer function of the band-pass filter 1 from overall “1”. In other words, a second adder block 6 and inverter block 5 are provided, and the second adder block 6 subtracts the output of the band-pass block 1 from the input of the band-pass block 1, to obtain the band-elimination transfer function (equation (8)).

That is, the following equation (9) is calculated to obtain the transfer function for the band-elimination block of equation (8).

$$\begin{matrix}[ E 9 ] & \\ \begin{matrix}1 - {T}_{BPF} ( S ) = 1 - \frac{\frac{{ω}_{0}}{α \cdot Q} \cdot S}{{S}^{2} + \frac{{ω}_{0}}{α \cdot Q} \cdot S + {ω}_{0}^{2}} \\ = \frac{{S}^{2} + {ω}_{0}^{2}}{{S}^{2} + \frac{{ω}_{0}}{Q} \cdot S + {ω}_{0}^{2}} \\ = {T}_{BEF} ( S )\end{matrix} & ( 9 )\end{matrix}$$

Hence at point A in FIG. 2, the same transfer function as at point A in FIG. 1 is obtained. And, by amplifying the band-elimination component and applying negative feedback to the input to the band-pass block 1, a band-pass filter with various pass band width is configured.

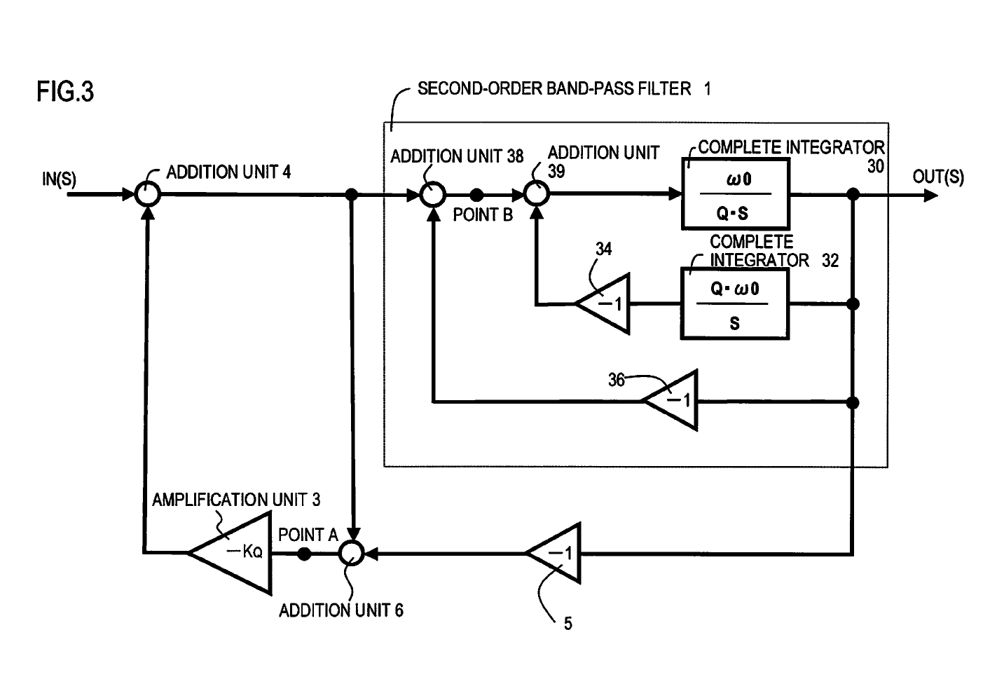

FIG. 3 is a transfer function block diagram of the band-pass filter with variable pass band width of a third embodiment of the invention. In FIG. 3, portions which are the same as in FIG. 2 are assigned the same symbols.

In FIG. 3, the block configuration of the band-pass filter 1 in FIG. 2 is replaced with a negative feedback circuit including a complete integrator 30, a complete integrator 32, a third adder block 38, a fourth adder block 39, and inverter blocks 34 and 36. That is, here the TBPF0(S) of equation (4) is analyzed into components. By thus expanding the block to the level of complete integrators, substitution with still more arbitrary transistor-level circuits is possible.

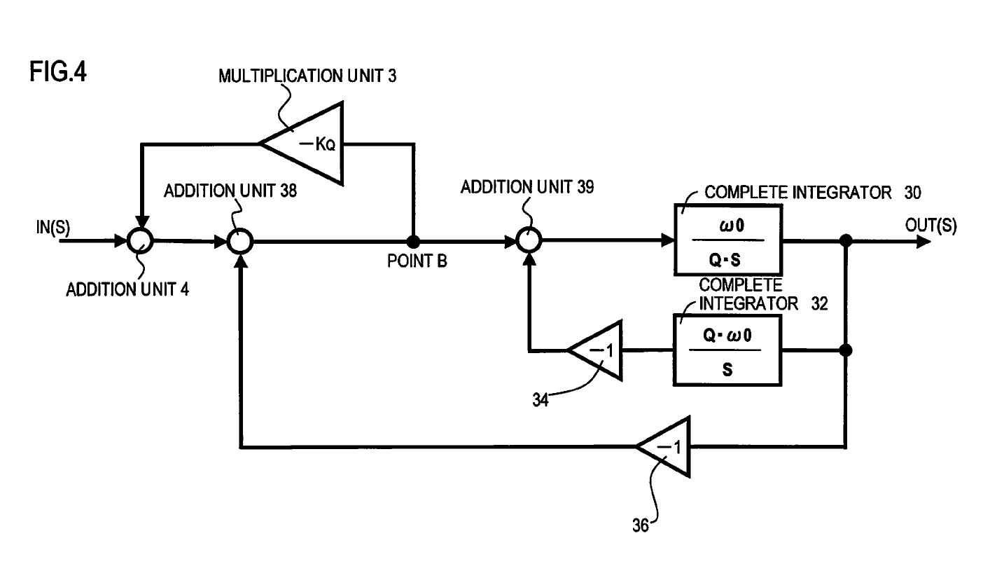

FIG. 4 is a transfer function block diagram of the band-pass filter with variable pass band width of a fourth embodiment of the invention. In FIG. 4, portions which are the same as in FIG. 2 and FIG. 3 are assigned the same symbols.

FIG. 4 has substantially the same configuration as FIG. 3, but is somewhat simplified. In FIG. 3, focusing on the outputs of the block including the inverter block 5 and adder block 6 and of the block including the inverter block 36 and adder block 38, the transfer function is the same for the output point A of the adder block 6 and for the output point B of the adder block 38. Hence there is no change even when the input to the amplifier block 3 in FIG. 3 (point A) is taken from point B.

Hence, in FIG. 4 the adder block 6 and inverter block 5 of FIG. 3 are removed, and the input of the amplifier block 3 is connected to the output point B of the adder block 38. By this construction, a component block can be eliminated, and the circuit scale can be further reduced.

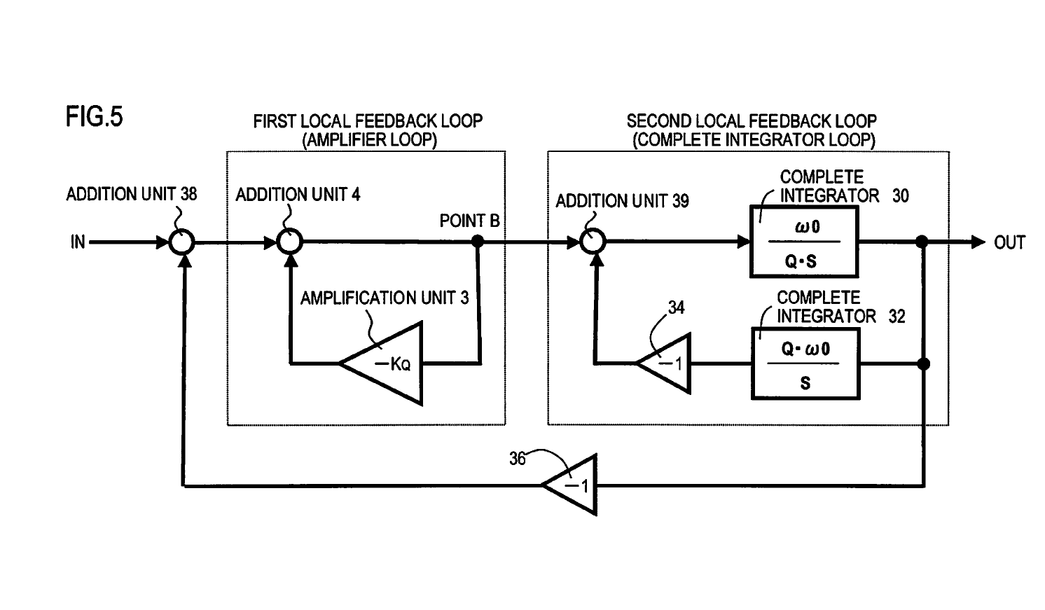

FIG. 5 is a transfer function block diagram of the band-pass filter with variable pass band width of a fifth embodiment of the invention. In FIG. 5, portions which are the same as in FIG. 2, FIG. 3 and FIG. 4 are assigned the same symbols.

Similarly to FIG. 3 and FIG. 4, in FIG. 5, the band-pass block 1 in FIG. 2 is substituted by a negative feedback circuit including two integrators 30 and 32. The configuration of FIG. 5 is essentially the same as that of FIG. 4, but the positions of the first adder block 4 and the third adder block 38 in FIG. 4 are interchanged. By this representation, the band-pass filter with variable pass band width of this embodiment can be represented as a negative feedback loop configuration including a first local feedback loop, including the amplifier block 3, a second local feedback loop, including the complete integrators 30 and 32.

The configuration as indicated from FIG. 3 to FIG. 5 are all examples in which the adder blocks have two inputs and one output; however, the two two-input, one-output adder blocks may be represented by a single three-input, one-output adder block. For example, the adder block 4 and adder block 38 in FIG. 3, and the adder block 4 and adder block 38 in FIG. 4 and FIG. 5, may all be replaced with a single three-input adder block.

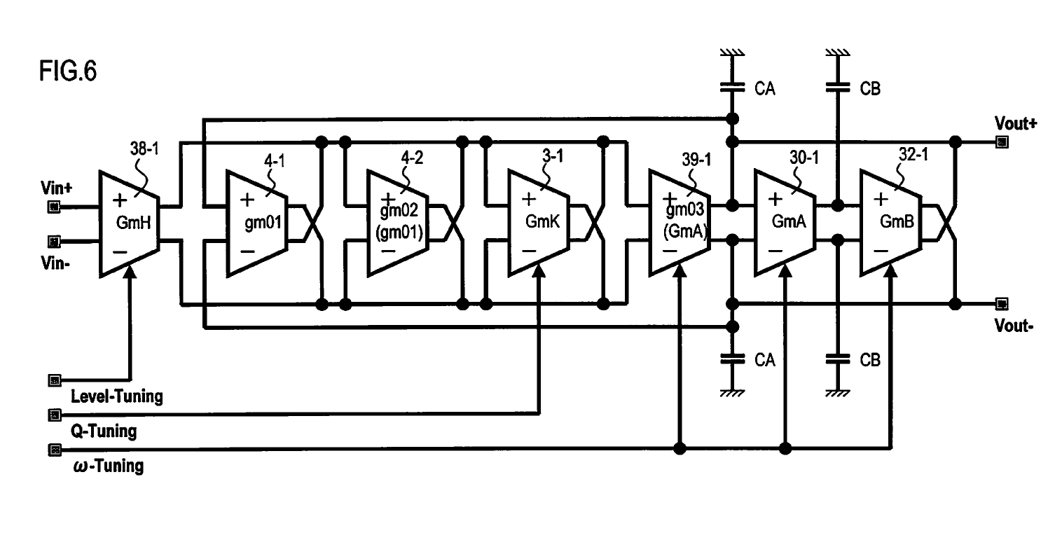

FIG. 6 is a circuit configuration diagram of an embodiment of a band-pass filter with variable pass band width in the block configuration of FIG. 5. In FIG. 6, the integrators 30, 32 of FIG. 5 are replaced with Gm-C (transconductance-capacitance) elements 30-1, 32-1, and the variable amplifier block 3 and signal adder blocks 4, 38, 39 are replaced with Gm (transconductance) elements 3-1, 4-1, 4-2, 38-1, 39-1.

The transfer function of this band-pass filter is expressed by equation (10) below.

$$\begin{matrix}[ E 10 ] & \\ {T}_{BPF} ( S ) = \frac{{G}_{mH}}{{g}_{m 01}} \cdot \frac{\frac{{g}_{m 01}}{{G}_{mK} + {g}_{m 02}} \cdot \frac{{g}_{m 03}}{{C}_{A}} \cdot S}{{S}^{2} + \frac{{g}_{m 01}}{{G}_{mK} + {g}_{m 02}} \cdot \frac{{g}_{m 03}}{{C}_{A}} \cdot S + \frac{{G}_{m A} \cdot {G}_{mB}}{{C}_{A} \cdot {C}_{B}}} & ( 10 )\end{matrix}$$

In equation (10), when the Gm values of the Gm elements 4-1 and 4-2 are equal, and when the Gm values of the Gm elements 39-1 and 30-1 are equal, then equation (10) can be rewritten as equation (11). In order to make the Gm values equal, it is sufficient to use the same circuit cells.

$$\begin{matrix}[ E 11 ] & \\ {T}_{BPF} ( S ) = ( \frac{{G}_{mH}}{{g}_{m 01}} ) \cdot \frac{\frac{1}{( \frac{{G}_{mK}}{{g}_{m 01}} ) + 1} \cdot \frac{{G}_{mA}}{{C}_{A}} \cdot S}{{S}^{2} + \frac{1}{( \frac{{G}_{mK}}{{g}_{m 01}} ) + 1} \cdot \frac{{G}_{m A}}{{C}_{A}} \cdot S + \frac{{G}_{m A} \cdot {G}_{mB}}{{C}_{A} \cdot {C}_{B}}} & ( 11 )\end{matrix}$$

From equation (11), compared with equation (3), the resonance frequency ω0 is given by the following equation (12).

$$\begin{matrix}[ E 12 ] & \\ ω 0 = \sqrt{\frac{{G}_{mA} \cdot {G}_{mB}}{{C}_{A} \cdot {C}_{B}}} & ( 12 )\end{matrix}$$

Similarly, from equation (11), the selectivity Q is given by equation (13) below.

$$\begin{matrix}[ E 13 ] & \\ Q = \sqrt{\frac{{C}_{A}}{{C}_{B}} \cdot \frac{{G}_{mB}}{{G}_{mA}}} \cdot ( 1 + \frac{{G}_{mK}}{{g}_{m 01}} ) ≡ {Q}_{0} \cdot ( 1 + {K}_{Q} ) & ( 13 )\end{matrix}$$

As is clear from equation (12), the resonance frequency ω0 is a function of the product of the Gm values GmA and GmB of the Gm elements 30-1 and 32-1, and can be controlled electronically. Further, the selectivity Q0 in equation (13) is the initial design value of Q, and is given by the ratio of the capacitances of the capacitors CA and CB, and by the ratio of the Gm values GmA and GmB of the Gm elements 30-1 and 32-1, and is a constant. And, as indicated in equation (13), the selectivity Q is the initial design value Q0 multiplied by (1+KQ).

As a result, the Q multiplication coefficient KQ is expressed by equation (14) below.

$$\begin{matrix}[ E 14 ] & \\ Q multiplication parameter coefficient \text{:} {K}_{Q} = \frac{{G}_{mK}}{{g}_{m 01}} & ( 14 )\end{matrix}$$

In this way, as is clear from equations (13) and (14), by adjusting the Gm value Gmk of the Gm amplifier 3-1, it is possible to change only the selectivity or Q factor, independently of the center frequency ω0. And, to adjust the center frequency ω0, the Gm values GmA and GmB of the Gm elements 30-1 and 32-1, and the Gm value gm03 of the addition Gm element 39-1, are changed in coordination. That is, as shown in FIG. 6, adjustment can be performed by inputting the Q factor adjusted input to the Gm amplifier 3-1, by inputting the settings for the center frequency ω to the Gm elements 30-1, 32-1, 39-1, and by then modifying each of the Gm values.

The Gm value GmH of the Gm element 38-1 is a parameter used to adjust the gain of the circuit as a whole. In this way, in the circuit of this embodiment, orthogonal (independent) adjustment of each of the parameters Q, ω0, and the overall level (average gain), is possible.

(Magnetic Storage Device)

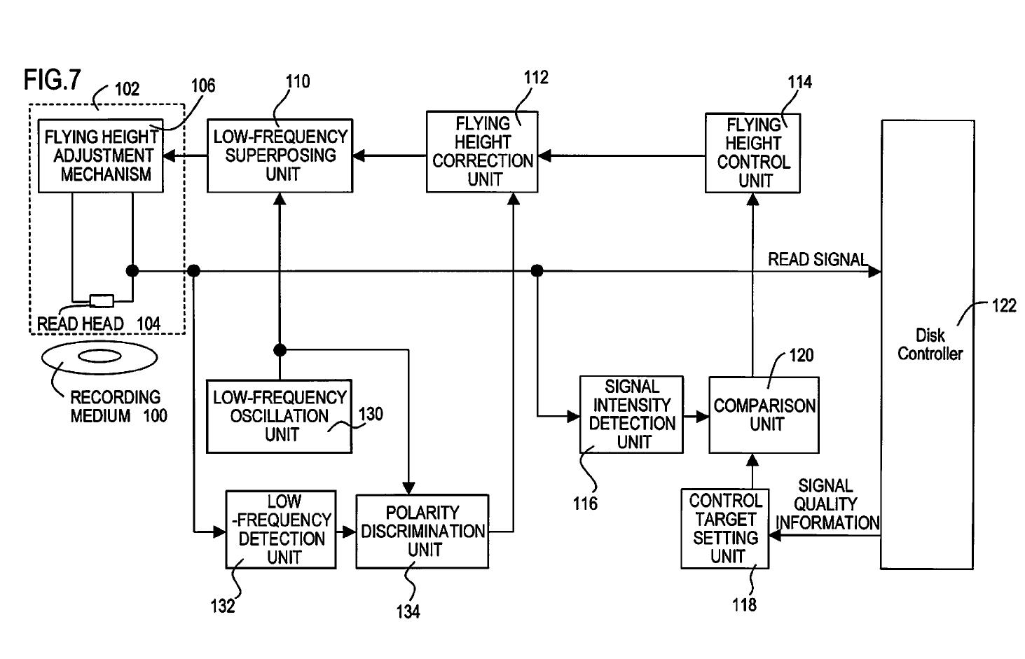

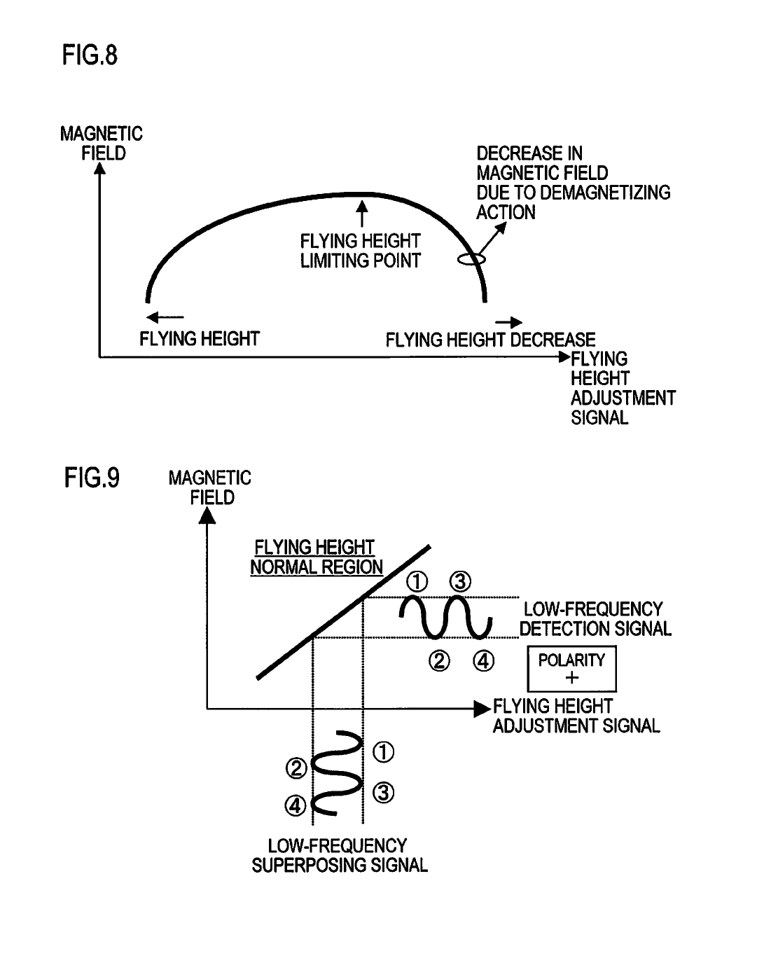

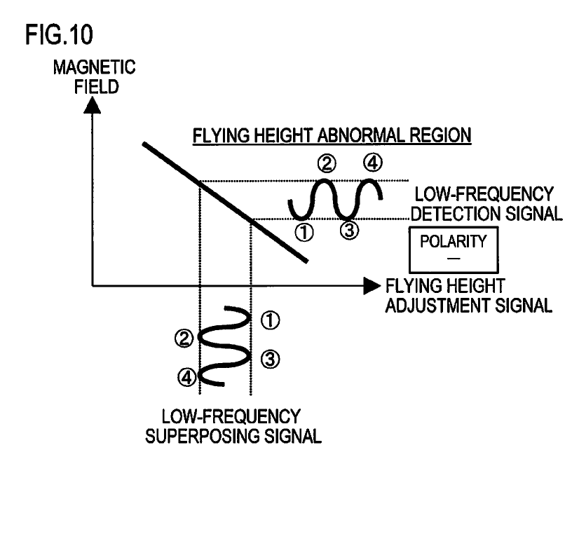

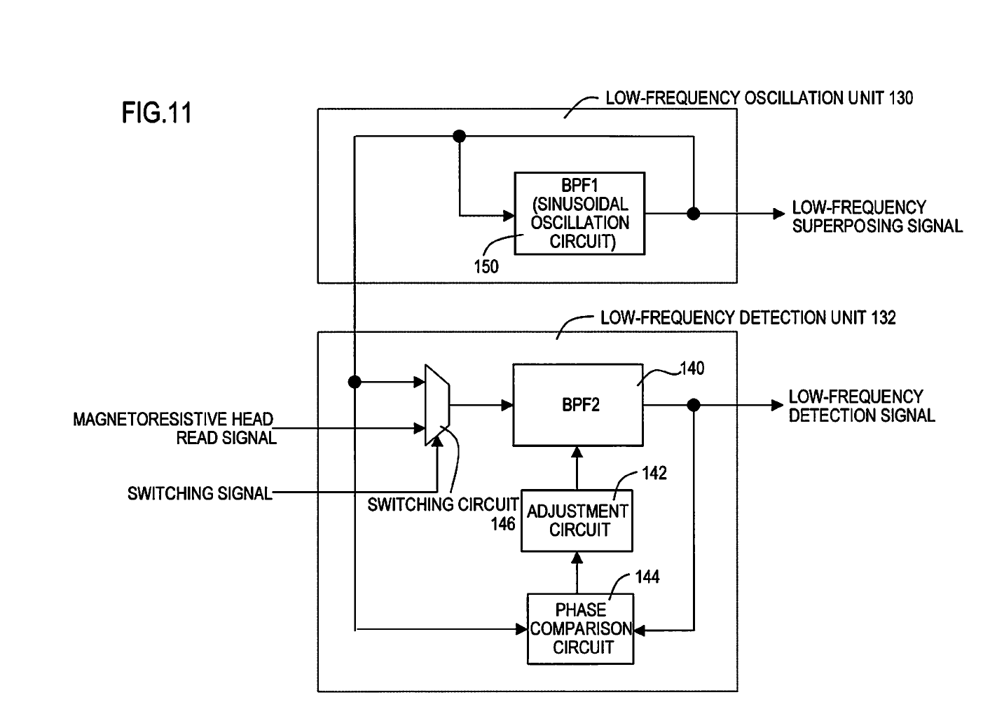

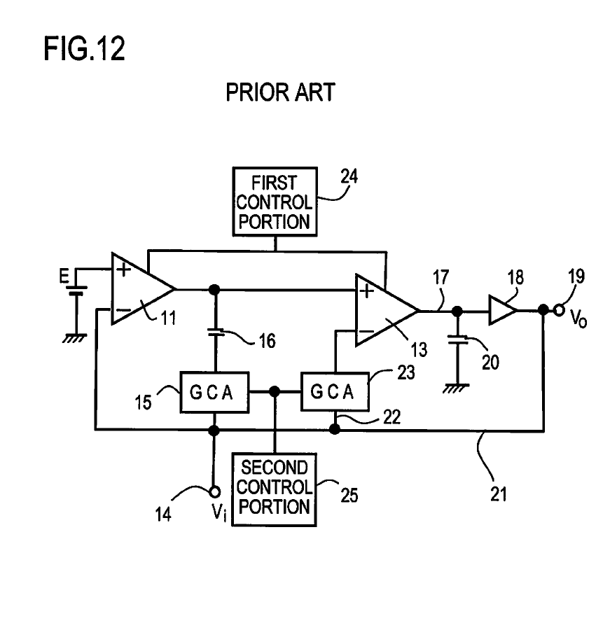

FIG. 7 is a block diagram of one embodiment of a magnetic storage device using an active band-pass filter of this invention, FIG. 8 is an explanatory diagram of flying height detection in the magnetic storage device of FIG. 7, FIG. 9 is an explanatory diagram of detection operation in the normal flying height region for FIG. 7, FIG. 10 is an explanatory diagram of detection operation in an abnormal flying height region of FIG. 7, and FIG. 11 is a block diagram of an oscillation circuit and detection circuit of FIG. 7. FIG. 7 shows an example of a magnetic disk device as the magnetic storage device.

FIG. 7 shows a magnetic disk device in which the slider flying height is controlled through the amount of heating of a heater provided on the slider. In FIG. 7, the slider 102 has a flying height adjustment mechanism 106, read element 104, and write element, not shown.

The flying height adjustment mechanism 106 includes a heater for heating provided in proximity to the read element 104, and a supply circuit which supplies current to this heater. The supply circuit is input control signals from a flying height control circuit 114, via a flying height correction circuit 112 and low-frequency superposing circuit 110.

The supply circuit supplies current to the heater of magnitude corresponding to this control signal, and the heater generates heat in an amount according to the magnitude of the current supplied. By this heat generation, thermal expansion occurs in the flying height adjustment mechanism (a portion of the slider) 106, and the flying height of the read element 104 with respect to the recording medium (magnetic disk) 100 is adjusted.

In general, when the read element 104 is far from the recording medium 100 the reproduction signal intensity decreases, and conversely, when the read element 104 approaches the recording medium 100 the reproduction signal intensity increases. For this reason, a flying height control loop is provided in which signal detection unit 116 detects the signal intensity of the output from the read element 104, a comparison circuit 120 compares the intensity with a standard value of a control target setting circuit 118 set by a disk controller 122, and the comparison result is received by the flying height control circuit 114.

The flying height control circuit 114 uses the result of comparison by the comparison circuit 120 of the signal intensity and the reference values, increases the flying height adjustment signal applied to the heater when the signal intensity is lower than the reference value, and conversely, decreases the flying height adjustment signal when the reproduction signal intensity is higher than the reference value. In essence, the head flying height is maintained within a tolerance range such that information recording and reproduction are not affected.

Moreover, a low-frequency signal generated by a low-frequency oscillation circuit 130 is superposed by the low-frequency superposing circuit 110 onto the flying height control signal, so as to cause the flying height of the read element 104 to fluctuate at a prescribed low frequency. By this superposing, the flying height of the read element 104 fluctuates gently about a certain reference flying height, and this is accompanied by gentle fluctuations in the signal intensity of the reproduction signal.

A polarity discrimination circuit 134 compares the polarities of the original low-frequency superposing signal superposed on the flying height control signal, and the low-frequency superposing signal extracted from the reproduction signal by a low-frequency detection circuit 132.

According to the sign of the polarities, the flying height correction circuit 112 appropriately corrects the control signal such that the flying height is equal to or greater than a limiting flying height, or performs other correction, executing control of the flying height so as to avoid demagnetizing action, described below. The base-band filter of an embodiment of this invention is applied to the above-described low-frequency detection circuit 132 and low-frequency oscillation circuit 130.

FIG. 8 is used to explain demagnetizing action. Normally the flying height adjustment signal is made large, and as the flying height declines, the detected magnetic field intensity increases. But depending on the head, a phenomenon may be seen in which the magnetic field intensity falls instead of rising when the flying height falls below a certain limiting point. This is due to demagnetizing action, and occurs because, when the medium coercive force is low, the magnetic field from the magnetic head acts in a direction which cancels the signal magnetic field of the medium.

FIG. 8 is a schematic diagram showing the relation between flying height when there is demagnetizing action, and the magnetic field intensity detected by the read element; the horizontal axis indicates the flying height adjustment signal, and the vertical axis plots the magnetic field intensity from the recording medium detected by the read element. The magnetic field intensity detected by the read element can be regarded directly as the read signal intensity.

As indicated by FIG. 8, the opposite change in the reproduction signal intensity when the flying height is higher than the above-described flying height limiting point and no demagnetizing action occurs, and when the flying height is lower than the above flying height limiting point and demagnetizing action occurs.

When demagnetizing action occurs in this way, in the case of normal negative feedback control, the flying height control mechanism 106 causes the head to approach still more closely to the recording medium 100, despite the fact that the read element 104 has already approached too closely to the recording medium 100.

As a result, there are concerns that the head may approach extraordinarily close to the recording medium 100, or may make contact with the medium 100, resulting in the occurrence of a crash or other problem. For this reason, when executing control based on the magnetic field intensity, discriminating the region of demagnetizing action, it is judged whether the head flying position is in the region of demagnetizing action, it is necessary to perform correction to the normal region when judging that the head flying position is in the region of demagnetizing action.

As this discrimination method, a method is conceivable in which low-frequency dithering of the control signal of the flying height control mechanism 106 is performed, and the polarities of the detected signal dithering component and of the applied dithering component are compared.

The low-frequency oscillation circuit 130 using a band-pass filter of this embodiment is means for generating a dithering signal, and the low-frequency detection circuit 132 employing a band-pass filter of this embodiment is means for detecting the superposed dithering signal from the read signal.

FIG. 9 and FIG. 10 are used to explain the polarity discriminated by polarity discrimination means from the superposing and detection of this low-frequency signal.

FIG. 9 is a partial enlarged diagram of FIG. 8, for a case in which the magnitude of the flying height adjustment signal is lower than the signal level corresponding to the flying height limiting point and demagnetizing action does not occur; FIG. 10 is a partial enlarged diagram of FIG. 8, for a case in which the magnitude of the flying height adjustment signal is higher than the signal level corresponding to the flying height limiting point and demagnetizing action does occur.

As explained above, when there is no occurrence of demagnetizing action, as the flying height adjustment signal grows stronger, that is, as the flying height declines, the intensity of the magnetic field detected by the read element 104, that is, the reproduction signal intensity, increases. As a result, as shown in FIG. 9, the polarity of the low-frequency detection signal relative to the low-frequency superposing signal superposed on the flying height adjustment signal is positive.

On the other hand, when demagnetizing action occurs, in contrast with times in which there is no demagnetizing action, as the flying height declines, the magnetic field intensity detected by the read element 104, that is, the reproduction signal intensity, decreases. As a result, as shown in FIG. 10, the polarity of the low-frequency detection signal relative to the low-frequency superposing signal superposed on the flying height adjustment signal becomes negative.

In this way, according to the sign of the polarity, it is possible to discriminate whether the head position is in the normal region or the abnormal (demagnetizing) region.

FIG. 11 is a block diagram of an embodiment of low-frequency oscillation unit and low-frequency detection unit using band-pass filters of an embodiment of the invention; as the circuit 132 to detect low-frequency dithering signals, the band-pass filter 140 is used, and as the dithering oscillation circuit 130, the band-pass filter 150 is used in a loop configuration.

The band-pass filter 150 has a gain at the resonance frequency of unity and a phase shift of 0 degrees, so that by forming a loop, a sinusoidal oscillation circuit 130 which oscillates at the resonance frequency results. The low-frequency signal resulting from this oscillation is passed to the low-frequency superposing circuit 110 and to the polarity discrimination circuit 134 in FIG. 7.

When the oscillation circuit 130 and detection circuit 132 are configured using band-pass filter circuits 150, 140 in the same circuit cell, a paired dithering oscillation circuit and detection circuit with good relative precision are obtained.

In order to obtain still higher precision, the output of the oscillation circuit 130 is input to the detection circuit 132, the relative phases of the oscillation circuit output and detection circuit output are compared, and the detection circuit is adjusted such that the phase difference becomes zero.

To perform this adjustment, in the present embodiment, adjustment of the circuit state of this band-pass filter 140 is executed with prescribed timing through instructions from a disk controller 122 (see FIG. 7).

This configuration is explained. The low-frequency detection circuit 132 includes a switching circuit 140, which receives a switching signal from the disk controller 122 and switches the input to the band-pass filter 140 between the reproduction signal from the read element 104 and the low-frequency oscillation signal of the oscillation circuit 130; a phase comparison circuit 144, which, when the low-frequency oscillation signal is input to the band-pass filter 140, compares the phases of the input low-frequency signal and the output low-frequency detection signal, and detects the phase shift therebetween; and, an adjustment circuit 142, which adjusts the circuit state of the band-pass filter 140 such that the phase shift detected by the phase comparison circuit 144 is canceled.

Through the operation of these circuits, the band-pass filter 140 of the low-frequency detection circuit 132 can extract and output the low-frequency detection signal in a desired state from the reproduction signal during information reproduction.

The ability to independently adjust the above-described Q factor and the center frequency ω0 during such adjustment of low-frequency detection is extremely useful with respect to improving precision, and moreover adjustments can easily be made even when characteristics change for each read element. Further, in detection of the occurrence of demagnetizing action, as explained above, a polarity discrimination circuit 134 can discriminate the polarity of a low-frequency detection signal with respect to a low-frequency superposing signal output by a low-frequency oscillation circuit 130.

### Other Embodiments

In the above-described embodiment, a magnetic disk device equipped with magnetic disks was explained; but application to other magnetic storage devices is also possible. Similarly, an example of flying height control was explained, but application to read signal reproduction systems and received signal demodulation systems is also possible.

For a band-pass block, by configuring a negative feedback circuit using a series-connected circuit of a second-order band-elimination block having a denominator polynomial equal to the band-pass block and an amplifier block which amplifies the output of the band-elimination block, through the amplification of the amplifier block, the band width can be controlled independently of the frequency, adjustment is made easy, and moreover the circuit configuration can be simplified.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An active band-pass filter, comprising:
a band-pass block;
a band-elimination block that blocks a prescribed band of signals branched from an input to the band-pass block;
an amplifier block that amplifies output of the band-elimination block; and
a signal combining block that adds the input to the band-pass block to an inverted signal of the output of the amplifier block, and feeds back the added result to the band-pass block,
wherein a pass band width is adjusted by setting amplification for the signal amplifier block.

2. The active band-pass filter according to claim 1, wherein the band-elimination block comprises a second signal combining unit that adds the input to the band-pass block to the inverted output of the band-pass block.

3. The active band-pass filter according to claim 1, wherein the band-pass block comprises:
a first integration block;
a second integration block that takes as input the output of the first integration block; and
a third signal combining block that adds the input to the band-pass block to the inverted output thereof and adds the addition result to the inverted output of the second integration block, and inputs the result to the first integration block.

4. The active band-pass filter according to claim 3, wherein the third signal combining block comprises:
a fourth signal combining block that adds the input to the band-pass block to the inverted output thereof; and
a fifth signal combining block that adds the output of the fourth signal combining block to the inverted output of the second integration block, and inputs the result to the first integration block.

5. The active band-pass filter according to claim 4, wherein the amplifier block takes as input the output of the fourth signal combining block.

6. The active band-pass filter according to claim 1, further comprising: a first local negative feedback circuit of a loop of the first signal combining block and the amplifier block;
a second local negative feedback circuit, connected to the first local negative feedback circuit and comprising a first integration block, a second integration block that takes as input the output of the first integration block, and a fourth signal combining block that adds the input to the band-pass block to the inverted output thereof; and
a sixth signal combining unit that combines the inverted output and the input of the first integration unit.

7. The active band-pass filter according to claim 3, wherein the first and second integration blocks comprise a trans-conductance element and a capacitance element, and becomes adjustment of a center frequency according to the transconductance or the capacitance.

8. The active band-pass filter according to claim 1, wherein the band-pass block comprises a second-order transfer function filter,
and the band-elimination block comprises a second-order filter having a denominator equal to the denominator polynomial of the transfer function of the band-pass block.

9. The active band-pass filter according to claim 3, wherein a band-pass filter with second-order transfer function is formed by a negative feedback loop of the first integration block and the second integration block.

10. A magnetic storage device, comprising:
a read element that reads signals from a recording medium; and
a frequency filter that passes in a prescribed band centered on a center frequency the signals read by the read element,
wherein the frequency filter comprises:
a band-pass block;
a band-elimination block that blocks a prescribed band of signals branched from input to the band-pass block;
an amplifier block that amplifies output of the band-elimination block; and
a signal combining block that adds together the input to the band-pass block and the inverted signal of the output of the amplifier block, and feeds back the result to the band-pass block,
and wherein a pass band width is adjusted by setting amplification for the signal amplifier block.

11. The magnetic storage device according to claim 10, wherein the band-elimination block comprises a second signal combining unit that adds the input to the band-pass block to the inverted output of the band-pass block.

12. The magnetic storage device according to claim 10, wherein the band-pass block comprises:
a first integration block;
a second integration block that takes as input the output of the first integration block; and
a third signal combining block that adds the input to the band-pass block to the inverted output thereof, and adds the addition result to the inverted output of the second integration block, and inputs the result to the first integration block.

13. The magnetic storage device according to claim 12, wherein the third signal combining block comprises:
a fourth signal combining block that adds the input to the band-pass block to the inverted output thereof; and
a fifth signal combining block that adds the output of the fourth signal combining block to the inverted output of the second integration block, and inputs the result to the first integration block.

14. The magnetic storage device according to claim 13, wherein the amplifier block takes as input the output of the fourth signal combining block.

15. The magnetic storage device according to claim 10, further comprising:
a first local negative feedback circuit of a loop of the first signal combining block and the amplifier block;
a second local negative feedback circuit, connected to the first local negative feedback circuit, and comprising a first integration block, a second integration block which takes as input the output of the first integration block, and a fourth signal combining block which adds together the input to the band-pass block and the inverted output thereof; and
a sixth signal combining unit that combines the inverted output and the input of the first integration unit.

16. The magnetic storage device according to claim 12, wherein the first and second integration blocks comprise a transconductance element and a capacitance element, and become adjustment of a center frequency according to the transconductance or the capacitance.

17. The magnetic storage device according to claim 10, wherein the band-pass block comprises a second-order transfer function filter,
and the band-elimination block comprises a second-order filter having a denominator equal to the denominator polynomial of the transfer function of the band-pass block.

18. The magnetic storage device according to claim 12, wherein a band-pass filter with second-order transfer function is formed by a negative feedback loop of the first integration block and the second integration block.

19. The magnetic storage device according to claim 10, further comprising:
a flying height adjustment mechanism that adjusts a flying height of the read element;
a control signal generation unit that generates control signals to control the flying height adjustment mechanism according to the signal output of the read element;
a signal extraction circuit that comprises the frequency filter, and that generates a low-frequency signal for superposing on the control signal and extracts the superposed low-frequency component from the signal output; and
a polarity judgment circuit that compares polarities of the superposed low-frequency signal and the extracted low-frequency component, and judges the polarity.

20. The magnetic storage device according to claim 19, wherein the signal extraction circuit comprises:
a low-frequency oscillation circuit connected in a loop with the frequency filter; and
a signal extraction circuit that comprises the frequency filter, and that extracts the superposed low-frequency component from the signal output.
